(19) United States
(12) Patent Application Publication
(10) Pub. No.: US 2026/0131857 A1
(43) Pub. Date: May 14, 2026

(54) BODY FOR VEHICLE

(71) Applicants: Hyundai Motor Company, Seoul (KR); Kia Corporation, Seoul (KR)

(72) Inventors: Kyeong Jae Kim, Hwaseong-si (KR); Jeon Woong Kang, Hwaseong-si (KR); Ji Woong Park, Hwaseong-si (KR); Yun A Cho, Hwaseong-si (KR)

(21) Appl. No.: 19/193,143

(22) Filed: Apr. 29, 2025

(30) Foreign Application Priority Data
Nov. 14, 2024 (KR) 10-2024-0162392

(51) Int. Cl. B62D 21/03; B62D 25/02; B62D 25/20

(52) U.S. Cl. CPC B62D 21/03; B62D 25/025; B62D 25/2036

(57) ABSTRACT

A body for a vehicle can include a pair of side sills respectively joining with each side end of a floor panel and a cross member extending across the floor panel, where the cross member has each end joining with both the side sills and the first reinforcement members respectively, and where the cross member has a cross-member height equal to or greater than a side-sill height of the side sill.

### CROSS-REFERENCE TO RELATED APPLICATIONS

The present application claims priority to Korean Patent Application No. 10-2024-0162392, filed Nov. 14, 2024, the entire contents of which is incorporated herein for all purposes by this reference.

### TECHNICAL FIELD

The present disclosure relates to a body for a vehicle.

### BACKGROUND

A fuel tank is positioned within the floor panel in conventional internal combustion engine vehicles while a high-voltage battery pack is positioned in the same place in electrified vehicles. The fuel tank in conventional internal combustion engine vehicles is placed at a sufficient distance from side impact barriers such as side sills, making them relatively safe in side impacts. However, in electrified vehicles, the increased battery capacity to extend the driving range has reduced the space between the battery pack and the side impact barriers such as a side sill, making them more vulnerable to side impacts.

The matters described above as background technology are intended to facilitate a better understanding of the background of the present disclosure and do not constitute an admission that the present disclosure pertains to the conventional technology already publicly known, available, or in use.

### SUMMARY

The present disclosure relates to a body for a vehicle that includes a pair of side sills respectively joining with each end of a floor panel and a cross member extending across the floor panel, having each end joining with both the side sill and a first reinforcement member respectively, and having a height equal to or greater than the height of the side sill.

An embodiment of the present disclosure can resolve the issue described above, and can provide a body for a vehicle that can include a floor panel, a pair of side sills respectively joining with each end of the floor panel, a pair of first reinforcement members respectively joining with the pair of side sills and disposed to face each other, and a cross member extending across the floor panel, having each end joining with both the side sill and the first reinforcement member respectively, and having a height equal to or greater than the height of the side sill.

The technical advantages discussed in the present disclosure are not limited to those explicitly mentioned, and other unmentioned technical features may be clearly understood by those skilled in the art to which the present disclosure pertains from the following description.

According to an embodiment of the present disclosure, a body of a vehicle may include: a floor panel; a pair of side sills respectively joining with each end of the floor panel; a pair of first reinforcement members respectively joining with the pair of side sills and disposed to face each other and a cross member extending across the floor panel, having each end joining with both the side sill and the first reinforcement member respectively, and having a height equal to or greater than the height of the side sill.

In an embodiment, the first reinforcement member may join with an upper portion of the side sill.

In an embodiment, the underside of the first reinforcement member may be formed in a shape matching the top surface of the side sill to allow surface-to-surface attachment onto the top surface of the side sill.

In an embodiment, a joining portion protruding downward may be formed on the outer side of the lower portion of the first reinforcement member to allow the joining portion to join with the outer surface of the side sill.

In an embodiment, the underside of the first reinforcement member may have the same width as the top surface of the side sill.

In an embodiment, the inner side of the first reinforcement member may be aligned with the inner side of the side sill in the up-down direction.

In an embodiment, the first reinforcement member may have a hollow interior, and a first reinforcement horizontal rib supporting both sides and a first reinforcement vertical rib supporting the top and bottom may be formed in the hollow interior of the first reinforcement member. The first reinforcement horizontal rib and the first reinforcement vertical rib may intersect to form a lattice structure.

In an embodiment, the first reinforcement horizontal rib may be disposed at the same height as the top surface of the cross member.

In an embodiment, the cross member may have a hollow interior and a cross member rib extending in the vehicle's width direction may be formed in the hollow interior of the cross member.

In an embodiment, the first reinforcement member may join with the upper portion of the side sill, and the cross member rib may be formed at the same height as the point where the first reinforcement member and the upper portion of the side sill join with each other.

In an embodiment, the first reinforcement member and the cross member may be extrudates molded by an extrusion method.

In an embodiment, the extrusion directions of the first reinforcement member and the cross member may intersect perpendicularly.

In an embodiment, a pair of side members disposed in the front or rear of the floor panel, distanced apart from each other in the vehicle's width direction, and joining with the outer surface of the cross member at each end may be further included.

In an embodiment, the end portion of the side member may be formed in a shape matching the outer surface of the cross member to allow surface-to-surface attachment onto the outer surface of the cross member.

In an embodiment, a protrusion may be formed at the end of the side member and the protrusion may join with the top surface of the cross member.

In an embodiment, the side member may join with the side sill and the first reinforcement member.

In an embodiment, the side surface of the end portion of the side member may be formed in a shape matching the side surfaces of the side sill and the first reinforcement member to allow surface-to-surface attachment onto the side sill and the first reinforcement member.

In an embodiment, a second reinforcement member disposed at a point where the side sill, the first reinforcement member, and the cross member join with each other, to join with the side sill, the first reinforcement member, and the cross member may be further included.

In an embodiment, the second reinforcement member may be panel-shaped to allow surface-to-surface attachment onto the side sill, the first reinforcement member, and the cross member while covering the side sill, the first reinforcement member, and the cross member.

According to a body for a vehicle of an embodiment of the present disclosure, the side sill and the cross member may more securely join with each other. This structure can allow the creation of a load path that may effectively disperse lateral loads and external impacts, thereby providing a rigid body for a vehicle that may protect high-voltage battery packs and passengers from external impacts.

The advantages achievable from an embodiment of the present disclosure are not necessarily limited to the advantages mentioned above, and other unmentioned advantages can be understood by those skilled in the art to which the present disclosure pertains from the following description.

### BRIEF DESCRIPTION OF THE DRAWINGS

FIG. 1 is a perspective view illustrating a body for a vehicle according to an embodiment of the present disclosure.

FIG. 2 is a perspective view illustrating a side sill according to an embodiment of the present disclosure.

FIG. 3 is a perspective view illustrating a first reinforcement member according to an embodiment of the present disclosure.

FIG. 4 is a perspective view illustrating a cross member according to an embodiment of the present disclosure.

FIG. 5 is a perspective view illustrating a side member according to an embodiment of the present disclosure.

FIG. 6 is a perspective view illustrating a second reinforcement member according to an embodiment of the present disclosure.

FIG. 7 is a perspective view for describing the joining between a second reinforcement member, a side sill, a first reinforcement member, a cross member, and a rear side member according to an embodiment of the present disclosure.

FIG. 8 is a view illustrating a cross-section taken along A-A′ in FIG. 1.

FIG. 9 is a view illustrating a cross-section taken along A-A′ in FIG. 1 according to another embodiment of the present disclosure.

### DETAILED DESCRIPTION OF ILLUSTRATIVE EMBODIMENTS

When it is determined that a specific description of the related and already known technology may obscure the essence of the example embodiments disclosed herein, the specific description can be omitted. It can be understood that the accompanying drawings are intended to facilitate understanding of the example embodiments disclosed herein and are not intended to necessarily limit the technical ideas disclosed herein, which are not necessarily limited to the accompanying drawings and can include modifications, equivalents, or substitutions within the spirit and technical scopes of the present disclosure. The following disclosure is not intended to necessarily limit the present disclosure to the described form or a particular field, and it is considered that various alternative embodiments and modifications of the present disclosure, whether explicitly stated or implied herein, can be possible. Those skilled in the art to which the present disclosure pertains can recognize that the forms and details of an embodiment of the present disclosure may be varied.

The present disclosure is described with reference to specific example embodiments. However, as can be understood by those skilled in the art to which the present disclosure pertains, various example embodiments described herein may be modified or otherwise implemented in a variety of different ways as long as they do not deviate from the spirit and scopes of the present disclosure. Accordingly, the following description is to be considered illustrative and is intended to instruct those skilled in the art to which the present disclosure pertains on methods of making and using various embodiments. The forms of disclosure illustrated and described herein can be considered as typical example embodiments. Equivalent elements, materials, processes, or steps may be substituted for those illustrated and described herein. Terms such as “including”, “comprising”, “consisting of”, “having, and “is” used herein are to be construed in a non-exclusive manner, i.e., the terms are construed to include items, components, or elements not explicitly described. References to the singular can be construed to include references to the plural where appropriate.

Various example embodiments described in the present specification can be considered as illustrative and explanatory, and not to be construed to necessarily limit the contents of the present disclosure. All references to “joining” (e.g., attached, affixed, coupled, connected, etc.) can be used to facilitate understanding of the present disclosure and are not to be construed to necessarily limit the position, orientation, or use of the configurations or the methods disclosed in the present specification. Accordingly, when a reference to joining is present, it can be interpreted broadly. Furthermore, such references to joining do not imply that two or more elements are necessarily directly connected to each other. Moreover, all numerical terms, such as “first”, “second”, ‘third”, “primary”, “secondary”, “major”, or any other generic or numerical terms can be taken only as identifiers to assist in the understanding of the various components, forms, variations, or modifications of an embodiment of the present disclosure and are not intended to be necessarily limitations to any component, form, variation, or modification, or to be necessarily any order or preference thereof. In other words, these expressions may be used to describe various components, but the components are not necessarily limited by such expressions. These expressions can be used merely to distinguish one component from another.

It is to be understood that when one component is referred to as being “connected” or “linked” to another component, the component may be directly connected or linked but there may be other components in between. In contrast, when one component is referred to as being “directly connected” or “directly linked” to another component, it can be understood that there is no other component in between.

Any number of components or various components in any configuration among the configurations described for example embodiments in the present specification may be included in another embodiment of the disclosure described in the present specification. The components of an embodiment may include any combination of features described in the present specification and may be arranged in any of the various configurations described in the present specification. The concepts related to the structure and arrangement of the components of embodiments of the present disclosure as well as concepts concerning their use and operation may apply to any number of embodiments in any combination as well as the specific example embodiments discussed in the present specification. Example embodiments, including those having various features in various arrangements, will be described below with reference to drawings.

Hereinafter, various example embodiments disclosed in the present specification will be described in detail with reference to the accompanying drawings. Identical or similar components can be assigned same reference numerals regardless of drawing designation, and repetitive descriptions thereof can be omitted.

A fuel tank can be positioned within the floor panel in conventional internal combustion engine vehicles while a high-voltage battery pack can be positioned in the same place in electrified vehicles. The fuel tank in conventional internal combustion vehicles can be placed at a sufficient distance from the side sill, such that they can be relatively safe in side impacts. However, in electric vehicles, the increased battery capacity to extend the driving range can reduce the space between the battery packs provided within the floor panel and the side sill, making them potentially more vulnerable to side impacts.

To address these issues, electric vehicles can replace the curved cross members used in conventional internal combustion engine vehicles with straight cross members that span the floor panel, aiming to achieve improved crash performance. However, vehicles with low overall height, designed to enhance aerodynamic performance by reducing air resistance, can experience a reduction in the physical overlap between the cross member and the side sill. This can make it difficult to create a load path that may effectively disperse lateral loads and external impacts, and can result in difficulties in protecting high-voltage battery packs and passengers from side impacts.

Accordingly, an embodiment of the present disclosure can provide a robust body for a vehicle configured to protect the high-voltage battery packs and passengers from external impacts by creating a load path that can effectively disperse lateral loads and external impacts through a structure in which the first reinforcement member can join with the side sill and thus the cross member and the side sill can more securely join with each other.

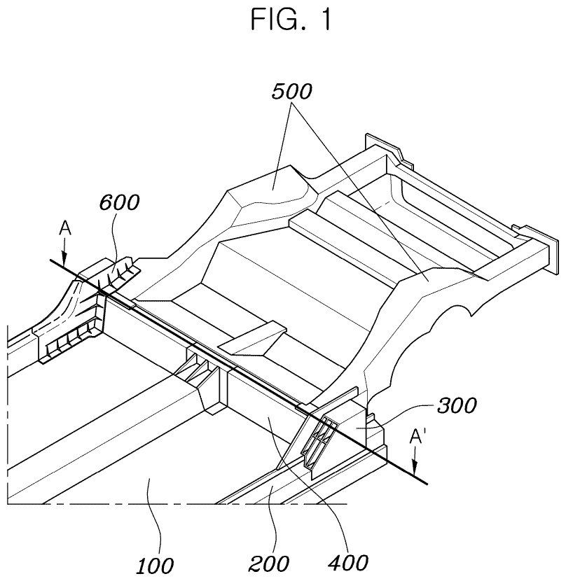

A body for a vehicle in example embodiments of the present disclosure illustrated in FIGS. 1 to 9 may include: a floor panel 100; a pair of side sills 200 respectively joining with each side end of the floor panel 100; a pair of first reinforcement members 300 respectively joining with the pair of side sills 200 and disposed to face each other; and a cross member 400 extending across the floor panel 100, having each end joining with both the side sill 200 and the first reinforcement member 300, respectively, and having a height equal to or greater than the height of the side sill 200.

More specifically, an end of the cross member 400 may join with both the side sill 200 and the first reinforcement member 300 joining with the side sill 200. In particular, the sum of the height of the side sill 200 and the first reinforcement member 300 may be equal to or greater than the height of the cross member 400 such that the joining area with the cross member 400 may increase compared to when the side sill 200 alone joins with the cross member 400. This structure can allow the creation of a load path that can effectively disperse lateral loads and external impacts, and thereby can protect high-voltage battery packs and passengers from external impacts.

In the following, the body for the vehicle of example embodiments of the present disclosure will be described focusing on the components.

In an embodiment, the pair of side sills 200 may respectively join with each side end of the floor panel 100.

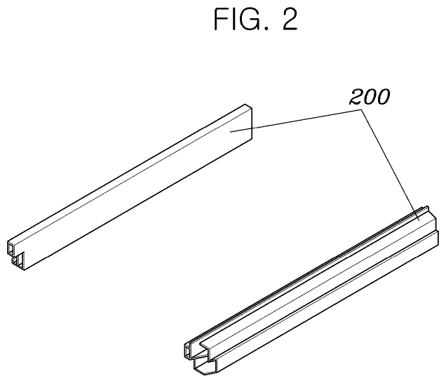

FIGS. 1 and 2 show that the pair of side sills 200 may be disposed at a distance from each other in the vehicle's width direction and may be disposed to extend in the length direction of the vehicle.

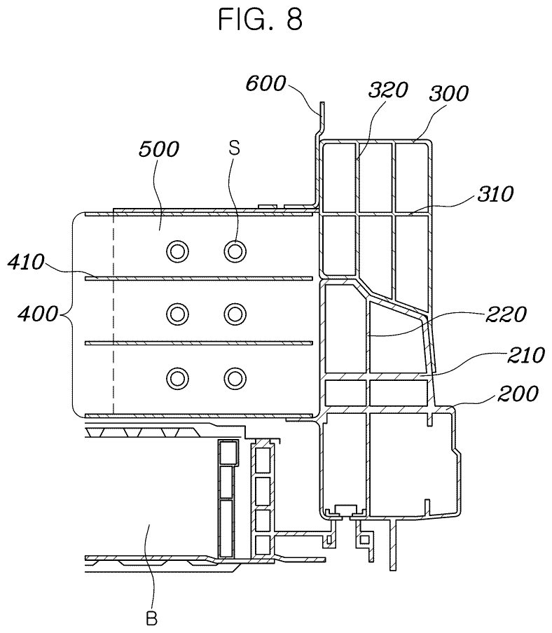

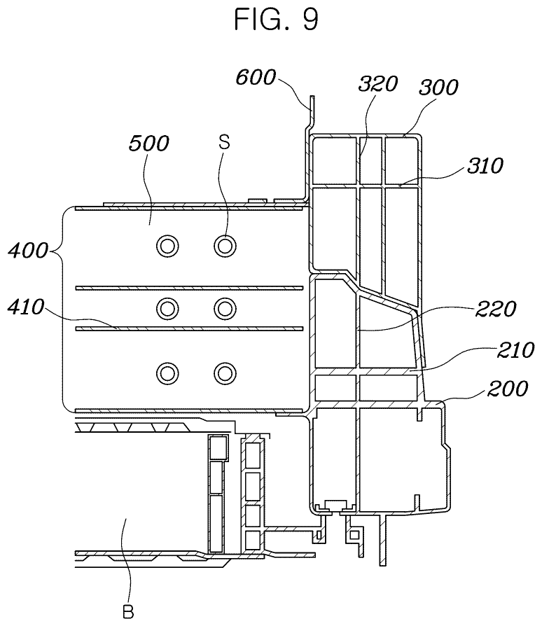

FIGS. 8 and 9 show that the side sill 200 may have a hollow interior to ensure lightweight. A side sill horizontal rib 210 supporting both sides of the side sill 200 and a side sill vertical rib 220 supporting the top and bottom of the side sill 200 may be formed in the hollow interior of the side sill 200. The side sill horizontal rib 210 and the side sill vertical rib 220 may intersect to form a lattice structure, and thereby can create load paths that can effectively disperse external impacts to allow the side sill 200 to simultaneously achieve lightweight and structural rigidity. The side sill vertical rib 220 may be aligned with a first reinforcement vertical rib 320, to be described below, in the up-down direction.

In an embodiment, the first reinforcement member 300 may join with each of the pair of side sills 200 and be disposed to face each other.

FIGS. 1 and 8 show that the first reinforcement member 300 may join with the upper portion of the side sill 200 and that the underside of the first reinforcement member 300 may be formed in a shape matching the top surface of the side sill 200 to allow surface-to-surface attachment onto the top surface of the side sill 200.

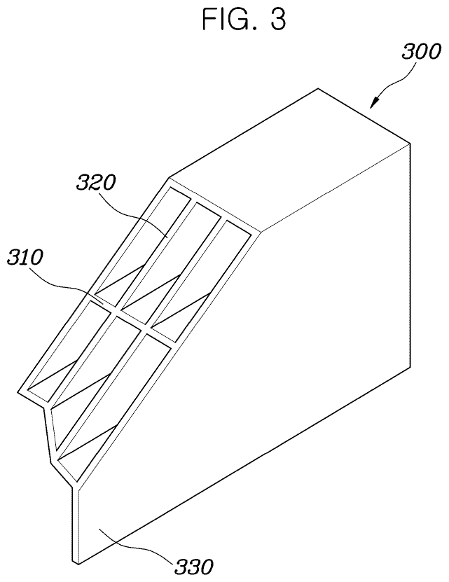

FIG. 3 shows that a joining portion 330 can protrude downward and may be formed on the outer side of the lower portion of the first reinforcement member 300 so that the joining portion 330 can join with the outer surface of the side sill 200 to allow the first reinforcement member 300 to join with the side sill 200 securely.

FIG. 8 shows that the width of the underside of the first reinforcement member 300 may be equal to the width of the top surface of the side sill 200 and the inner side of the first reinforcement member 300 may be aligned with the inner side of the side sill 200 in the up-down direction to allow the end of the cross member 400 to securely join with the inner side of the side sill 200 and the inner side of the first reinforcement member 300 without a gap.

The first reinforcement member 300 can have a hollow interior to ensure lightweight. A first reinforcement horizontal rib 310 can support both sides of the first reinforcement member 300 and a first reinforcement vertical rib 320 can support the top and bottom of the first reinforcement member 300 and may be formed in the hollow interior of the first reinforcement member 300. The first reinforcement horizontal rib 310 and the first reinforcement vertical rib 320 can intersect to form a lattice structure, thereby can create load paths that can effectively disperse external impacts.

The underside of the first reinforcement member 300 may be bent and the first reinforcement vertical rib 320 can be disposed at a point where the underside of the first reinforcement member 300 is bent to allow enhanced structural rigidity of the first reinforcement member 300.

The first reinforcement horizontal rib 310 can be disposed at the same height as the top surface of the cross member 400 to create load paths that can effectively disperse the side impacts and lateral loads. However, the first reinforcement horizontal rib 310 and the top surface of the cross member 400 are not necessarily disposed at the same height. As illustrated in FIG. 9, the first reinforcement horizontal rib 310 may be formed at a different height with an offset from the top surface of the cross member 400.

In an embodiment, the cross member 400 may extend across the floor panel 100, have each end joining with both the side sill 200 and the first reinforcement member 300, respectively, and have a height equal to or greater than the height of the side sill 200.

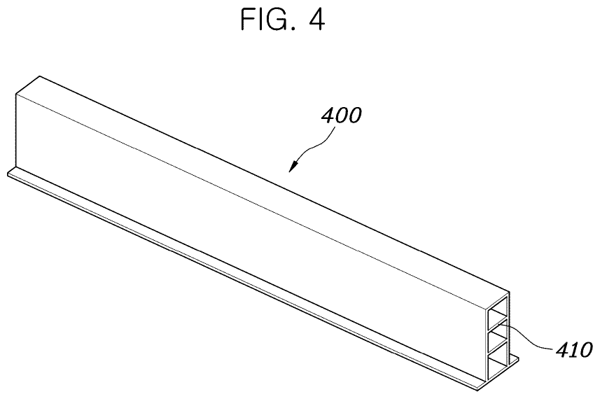

FIGS. 4 and 8 show that the cross member 400 may have a hollow interior to ensure lightweight. A cross member rib 410 can support both sides of the cross member and may be formed in the hollow interior of the cross member 400. A plurality of cross member ribs 410 may be formed and spaced apart in the height direction.

FIG. 8 shows that the cross member rib 410 can be formed at the same height as the point where the first reinforcement member 300 and the upper portion of the side sill 200 join with each other to create load paths that can effectively disperse side impacts and lateral loads so that the high-voltage battery pack B may be effectively protected.

FIG. 9 shows that the cross member rib 410 is not necessarily formed at the same height as the point where the first reinforcement member 300 and the upper portion of the side sill 200 join with each other. The cross member rib 410 may be formed at a different height with an offset from the point where the first reinforcement member 300 and the upper portion of the side sill 200 join with each other.

The first reinforcement member 300 and the cross member 400 may be molded by various methods such as an extrusion method, press method, and casting method. For example, the first reinforcement member 300 and the cross member 400 may be molded by the extrusion method. As illustrated in FIG. 1, the first reinforcement member 300 and the cross member 400 may be disposed such that the extrusion directions thereof intersect perpendicularly to create load paths that can effectively disperse side impacts and lateral loads, and thereby can ensure structural rigidity.

In an embodiment, a pair of side members 500 may be disposed in the front or rear of the floor panel 100, spaced apart in the vehicle's width direction, and joining with the outer surface of the cross member 400 at each end.

FIG. 1 shows that the side member 500 can be a rear side member positioned in the rear of the floor panel 100. In another embodiment, the side member 500 may be a front side member positioned in front of the floor panel 100.

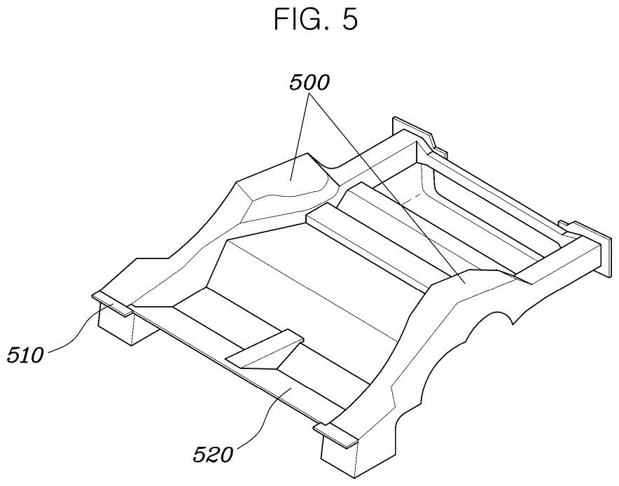

FIG. 5 shows that a pair of side members 500 may be disposed at a distance from each other in the vehicle's width direction and may join with each side end of the side floor panel 520.

The end of the side member 500 can be formed in a shape matching the outer surface of the cross member 400 to allow surface-to-surface attachment onto the outer surface of the cross member 400. More specifically, the front surface of the end of the side member 500 can be formed in a planar shape matching the outer surface of the cross member 400 in a planar shape as illustrated in FIG. 5, or the side member 500 may be attached surface-to-surface onto the outer surface of the cross member 400 as illustrated in FIG. 1.

FIG. 8 shows that the end of the side member 500 may join with the cross member 400 at a plurality of joining points S, and such joining may be made by various methods such as adhesion, mechanical fastening, and welding. For example, secure joining may be achieved through bolting at the plurality of joining points S.

FIG. 5 shows that a protrusion 510 can be formed at the end of the side member 500 and the protrusion 510 may join with the top surface of the cross member 400. More specifically, the protrusion 510 can be protruding forward and may be formed in the upper portion of the end of the side member 500, or the protrusion 510 may be attached surface-to-surface onto the top surface of the cross member 400 to securely join therewith when the side member 500 joins with the cross member 400 as illustrated in FIG. 1.

FIGS. 1 and 5 show that the side member 500 may join with the side sill 200 and the first reinforcement member 300 or the side surface of the end of the side member 500 may be shaped to match the side surface of the side sill 200 and the first reinforcement member 300 to allow surface-to-surface attachment onto the side sill 200 and the first reinforcement member 300. More specifically, the side surface of the end of the side member 500 may have a planar shape, and when the side member 500 joins with the side sill 200 and the first reinforcement member 300, the side surface of the end of the side member 500 may be attached surface-to-surface onto the inner side of the side sill 200 and the first reinforcement 300 to securely join therewith.

In an embodiment, a second reinforcement member 600 may be disposed at a point where the side sill 200, the first reinforcement member 300, and the cross member 400 join with each other, to join with the side sill 200, the first reinforcement member 300, and the cross member 400. The second reinforcement member 600 may be panel-shaped to be attached surface-to-surface onto the side sill 200, the first reinforcement member 300, and the cross member 400 while covering the side sill 200, the first reinforcement member 300, and the cross member 400.

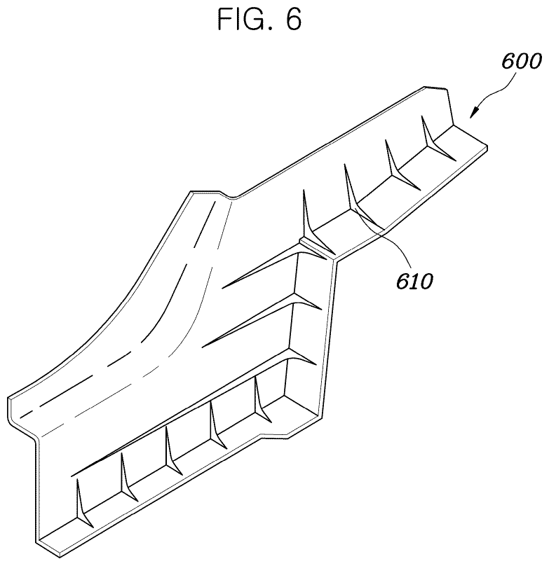

FIG. 6 shows that the second reinforcement member 600 may be panel-shaped, molded by a plate press method.

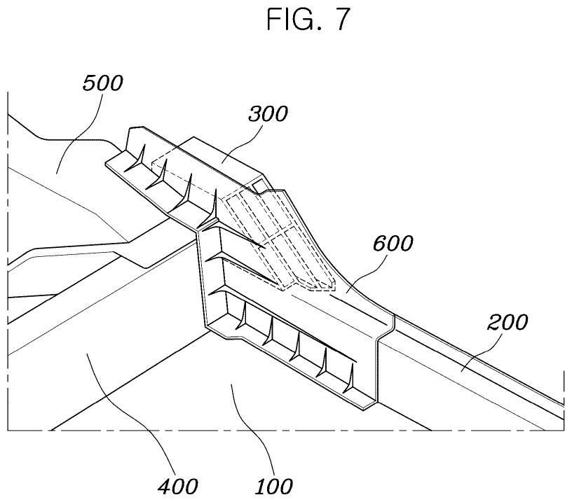

FIG. 7 shows that the second reinforcement member 600 may be disposed at a point where the side sill 200, the first reinforcement member 300, the cross member 400, and the side member 500 join with each other, and the second reinforcement member 600 may be panel-shape to be bent to allow surface-to-surface attachment onto the side sill 200, the first reinforcement member 300, and the cross member 400 while covering the side sill 200, the first reinforcement member 300, and the cross member 400. A plurality of second reinforcement ribs 610 may be formed along the bent portion in the second reinforcement member 600. This structure can allow the second reinforcement member 600 to cover the points more effectively where the side sill 200, the first reinforcement member 300, the cross member 400, and the side member 500 join with each other, and thereby can increase the joining strength of each component.

Specific example embodiments of the present disclosure have been illustrated and described, and those skilled in the art to which the present disclosure pertains can understand that an embodiment of the present disclosure may be variously improved upon and modified within scopes not deviating from the technical spirit of the present disclosure provided in the following patent claims.

What is claimed is:

1. A vehicle body, comprising:
a floor panel;
a pair of side sills respectively joining with each side end of the floor panel;
a pair of first reinforcement members respectively joining with the pair of side sills; and
a cross member extending across the floor panel, having each cross-member end joining with both one of the pair of side sills and one of the pair of first reinforcement members, respectively, and wherein the cross member has a cross-member height equal to or greater than a side-sill height of the pair of side sills.

2. The vehicle body of claim 1, wherein each of the pair of first reinforcement members joins with an upper portion of a respective one of the pair of side sills.

3. The vehicle body of claim 2, wherein an underside of each of the pair of first reinforcement members has a shape matching a top surface of a respective one of the pair of side sills in a configuration to be attached surface-to-surface onto the top surface of the respective one of the pair of side sills.

4. The vehicle body of claim 2, wherein each of the pair of first reinforcement members includes a joining portion protruding downward on an outer side thereof and from a lower portion thereof, wherein the joining portion joins with an outer surface of a respective one of the pair of side sills.

5. The vehicle body of claim 2, wherein an underside width of an underside portion of each of the pair of first reinforcement members is equal to a top-surface width of a top surface portion of a respective one of the pair of side sills.

6. The vehicle body of claim 2, wherein a first-reinforcement-member inner side of each of the pair of first reinforcement members is aligned with a side-sill inner side of a respective one of the pair of side sills in an up-down direction.

7. The vehicle body of claim 2, wherein each of the pair of first reinforcement members has a hollow interior, wherein each of the pair of first reinforcement members comprises a first reinforcement horizontal rib within the hollow interior and a first reinforcement vertical rib within the hollow interior, wherein the first reinforcement horizontal rib supports both sides of the each of the pair of first reinforcement members, wherein the first reinforcement vertical rib supports top and bottom of the each of the pair of first reinforcement members, and wherein the first reinforcement horizontal rib and the first reinforcement vertical rib intersect to form a lattice structure.

8. The vehicle body of claim 7, wherein the first reinforcement horizontal rib is disposed at a same height as a top surface of the cross member.

9. The vehicle body of claim 1, wherein the cross member has a hollow interior, wherein the cross member includes a cross member rib supporting both sides of the cross member in the hollow interior of the cross member.

10. The vehicle body of claim 9, wherein each of the pair of first reinforcement members joins with an upper portion of a respective one of the pair of side sills at a join point, and wherein the cross member rib is disposed at a same height as the join point.

11. The vehicle body of claim 1, wherein the pair of first reinforcement members and the cross member are extrudates molded by an extrusion method.

12. The vehicle body of claim 11, wherein the pair of first reinforcement members and the cross member are disposed such that extrusion directions thereof intersect perpendicularly.

13. The vehicle body of claim 1, further comprising a pair of side members disposed in front or rear of the floor panel, distanced apart from each other in a width direction of the vehicle body, and joining with an outer surface of the cross member.

14. The vehicle body of claim 13, wherein an end of each of the pair of side members has a shape matching the outer surface of the cross member to allow surface-to-surface attachment onto the outer surface of the cross member.

15. The vehicle body of claim 13, wherein each of the pair of side members includes a protrusion extending therefrom, wherein the protrusion joins with a top surface of the cross member.

16. The vehicle body of claim 13, wherein one of the pair of side members joins with one of the pair of side sills and one of the pair of first reinforcement members.

17. The vehicle body of claim 16, wherein a side-member side surface of an end of the one of the pair of side members is shaped to match a side-sill side surface of the one of the pair of side sills and a first-reinforcement-member side surface of the one of the pair of first reinforcement members to allow surface-to-surface attachment of the one of the pair of side members onto the one of the pair of side sills and the one of the pair of first reinforcement members.

18. The vehicle body of claim 1, further comprising a second reinforcement member disposed at a join point where one of the pair of side sills, one of the pair of first reinforcement members, and the cross member join with each other.

19. The vehicle body of claim 18, wherein the second reinforcement member is panel-shaped and configured to be attached surface-to-surface onto the one of the pair of side sills, the one of the pair of first reinforcement members, and the cross member while covering a portion of each of the one of the pair of side sills, the one of the pair of first reinforcement members, and the cross member.

20. A vehicle comprising the vehicle body of claim 1.
